(19) United States
(12) Patent Application Publication
(10) Pub. No.: US 2021/0122293 A1
(43) Pub. Date: Apr. 29, 2021

(54) PERIPHERAL INFORMATION ACQUISITION DEVICE AND VEHICLE

(71) Applicant: HONDA MOTOR CO., LTD., Minato-ku, Tokyo (JP)

(72) Inventors: Yoshimasa Hayashida, Wako-shi (JP); Yuji Kuwashima, Wako-shi (JP)

(21) Appl. No.: 17/057,135

(22) PCT Filed: Jun. 27, 2018
(86) PCT No.: PCT/JP2018/024349

§ 371 Date: Nov. 20, 2020

(51) Int. Cl. B60R 1/00; B60R 11/04; H04N 5/225; H04N 7/18

(52) U.S. Cl. CPC B60R 1/00; B60R 11/04; B60R 2011/004; H04N 7/18; H04N 5/2253

(57) ABSTRACT

The present invention is a peripheral information acquisition device including an imaging unit configured to perform imaging in a front side direction or a rear side direction of a vehicle and a stay configured to support the imaging unit on the vehicle, wherein the stay is formed so that the imaging unit is allowed to protrude outward from a side surface of the vehicle in a width direction of the vehicle, and wherein, in a structure including the imaging unit and the stay, an outermost part of the structure in the width direction of the vehicle is disposed more inward in the width direction of the vehicle than an outermost part of the vehicle in the width direction.

### TECHNICAL FIELD

The present invention relates to a peripheral information acquisition device and a vehicle.

### BACKGROUND ART

Technology for replacing side mirrors by discontinuing the side mirrors of a vehicle and displaying images captured by a camera is being studied. As technology related to this, technology described in Patent Literature 1 is known. The technology described in Patent Literature 1 involves disposing a camera under a side mirror to image a side region of a vehicle and display an image obtained through imaging on a display unit.

### CITATION LIST

### Patent Literature

### [Patent Literature 1]

PCT International Publication No. WO2016/125405

### SUMMARY OF INVENTION

### Technical Problem

How to dispose cameras at positions other than positions where the side mirrors are attached when the side mirrors are discontinued and only camera images are used has not been sufficiently studied.

In this regard, although the camera is disposed on the side mirror and an auxiliary visual field is secured using a video obtained through an imaging process of the camera in addition to a visual field of a mirror image obtained by the side mirror in the technology described in Patent Literature 1, the discontinuation of side mirrors is not considered.

The present invention has been made in consideration of such circumstances and an objective of the present invention is to provide a peripheral information acquisition device and a vehicle that do not give a sense of discomfort in a driver's vehicle sensation.

### Solution to Problem

A peripheral information acquisition device according to the present invention adopts the following configurations.

(1): According to an aspect of the present invention, there is provided a peripheral information acquisition device including: an imaging unit configured to perform imaging in a front side direction or a rear side direction of a vehicle; and a stay configured to support the imaging unit on the vehicle, wherein the stay is formed so that the imaging unit is allowed to protrude outward from a side surface of the vehicle in a width direction of the vehicle, and wherein, in a structure including the imaging unit and the stay, an outermost part of the structure in the width direction of the vehicle is disposed more inward in the width direction of the vehicle than an outermost part of the vehicle in the width direction.

(2): In the above-described aspect (1), the imaging unit is disposed in a region having a dead angle when viewed from a predetermined position in a region above a seat of a driver of the vehicle via the stay.

(3): In the above-described aspect (2), the imaging unit is disposed in a region having a dead angle when viewed from each position included within a predetermined region in the region above the seat of the driver of the vehicle via the stay.

(4): In any one of the above-described aspects (1) to (3), the imaging unit is attached to the vehicle without side mirrors via the stay and performs imaging in the rear side direction including a side surface of a rear part of the vehicle.

(5): In any one of the above-described aspects (1) to (4), the imaging unit is disposed on a pillar adjacent to a front windshield of the vehicle via the stay.

(6): In the above-described aspect (5), the imaging unit is disposed on the pillar within a blind spot caused by the pillar via the stay.

(7): In any one of the above-described aspects (1) to (4), the imaging unit is disposed on a non-vertical inclined surface in a fender of a front part of the vehicle via the stay.

(9): In any one of the above-described aspects (1) to (7), the peripheral information acquisition device further includes a display unit configured to display an image captured by the imaging unit, wherein the display unit displays a mark representing a position on an image of a part of a side surface of the vehicle or the outermost part of the vehicle in the width direction together with the image.

(9): According to an aspect of the present invention, there is provided a vehicle including: an imaging unit configured to perform imaging in a front side direction or a rear side direction of a vehicle body; and a stay configured to support the imaging unit on the vehicle body, wherein the stay is formed so that the imaging unit is allowed to protrude outward from a side surface of the vehicle body in a width direction of the vehicle body, and wherein, in a structure including the imaging unit and the stay, an outermost part of the structure in the width direction of the vehicle body is disposed more inward in the width direction of the vehicle body than an outermost part of the vehicle body in the width direction.

### Advantageous Effects of Invention

According to the aspects (1) to (9), it is possible to provide a driving environment that does not give a sense of discomfort in the driver's vehicle sensation.

According to the aspects (2), (3), (6), and (7), it is possible to secure a visual field from the driver's seat.

According to the aspects (4) and (8), it is possible to give a vehicle sensation to the driver in a vehicle width direction.

### BRIEF DESCRIPTION OF DRAWINGS

FIG. 1 is a block diagram showing an example of a configuration of a peripheral information acquisition device 1.

FIG. 2 is a front view showing an example of a structural configuration of the peripheral information acquisition device 1.

FIG. 3 is a plan view showing an example of a structural configuration of the peripheral information acquisition device 1.

FIG. 4 is a plan view showing an example of a first region R1.

FIG. 5 is a front view showing an example of a pattern of mounting positions of a structure Q.

FIG. 6 is a perspective view showing an example of a pattern of mounting positions of the structure Q.

FIG. 7 is a diagram showing an example of an arrangement position of the structure Q viewed from a driver's viewpoint E.

FIG. 8 is a diagram showing an example of an image IM1 displayed on a display unit 40.

FIG. 9 is a plan view showing an example of a mounting position of the structure Q according to a modified example.

### DESCRIPTION OF EMBODIMENTS

Embodiments of a peripheral information acquisition device of the present invention will be described below with reference to the drawings. Although a vehicle will be described below as being a right-hand steering wheel vehicle, it is only necessary to appropriately reverse the left and right in the following description content when the vehicle is a left-handling steering wheel vehicle.

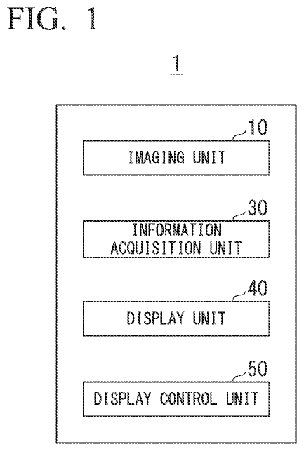

FIG. 1 is a block diagram showing an example of a configuration of a peripheral information acquisition device 1. The peripheral information acquisition device 1 includes an imaging unit 10, an information acquisition unit 30, a display unit 40, and a display control unit 50. The imaging unit 10 uses a camera to image a space including a region in a front side direction or a rear side direction of a vehicle M. The imaging unit 10 outputs data of a captured image to the information acquisition unit 30.

The information acquisition unit 30 outputs data of an image acquired from the imaging unit 10 to the display control unit 50. The display control unit 50 causes the display unit 40 to display an image based on the image captured by the imaging unit 10 on the basis of the data of the image acquired from the information acquisition unit 30.

The display control unit 50 is implemented by a processor such as a central processing unit (CPU) executing a program (software). The display control unit 50 may be implemented by hardware such as a large-scale integration (LSI) circuit, an application specific integrated circuit (ASIC), or a field-programmable gate array (FPGA) or may be implemented by software and hardware in cooperation.

The display unit 40 is implemented by, for example, a liquid crystal display, an organic EL display, or the like.

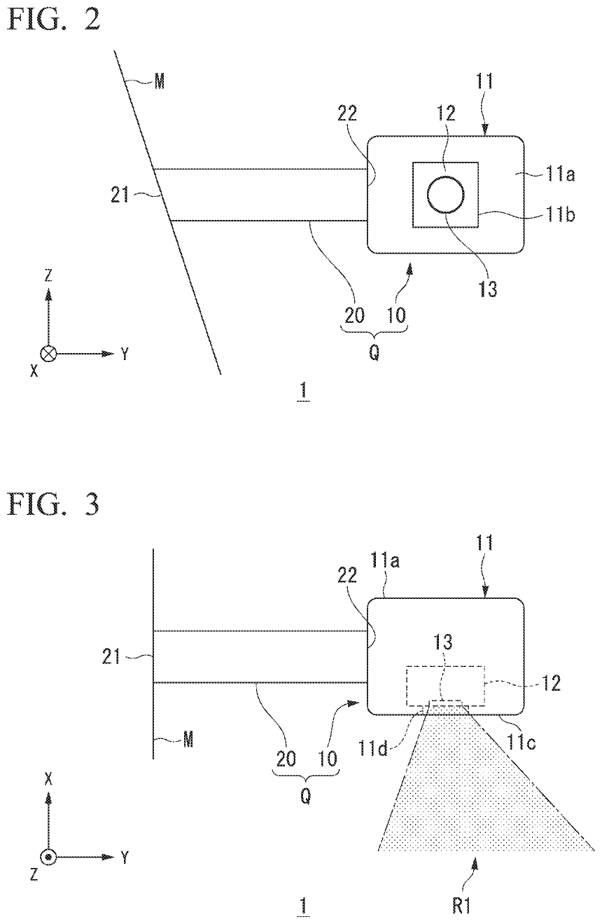

FIG. 2 is a front view showing an example of a structural configuration of the peripheral information acquisition device 1. FIG. 3 is a plan view showing an example of the structural configuration of the peripheral information acquisition device 1. Hereinafter, a structural arrangement relationship of the peripheral information acquisition device 1 will be described with reference to FIGS. 2 and 3.

Although the peripheral information acquisition device 1 on a driver's seat side (right side) will be described below, a similar device is also provided on a passenger's seat side (left side) at a symmetrical position in a width direction of the vehicle M.

The peripheral information acquisition device 1 includes, for example, an imaging unit 10 and a stay 20.

The imaging unit 10 includes, for example, a camera housing 11 and a camera 12 built in the camera housing 11. The camera housing 11 is a housing for incorporating the camera 12. The camera housing 11 is formed, for example, in a streamlined shape or a shape with rounded corners so that air resistance is reduced in a traveling direction of the vehicle M. The camera housing 11 may be integrally formed with the stay 20. In this case, a part of the camera housing 11 between the camera 10 and the vehicle may be integrally referred to as a stay 20.

In the following description, it is assumed that the camera housing 11 is not integrally formed with the stay 20 but is joined to the stay 20 by some means.

The camera 12 is, for example, a digital camera that uses a solid-state image sensor such as a charge coupled device (CCD) or a complementary metal oxide semiconductor (CMOS). The camera 12 may be an infrared camera that mainly detects infrared rays and generates an image from the detected infrared rays.

An opening 11d is provided on a back surface 11c side of the camera housing 11 when viewed from a front side (a forward direction side) of the vehicle M. The camera 12 is attached to the camera housing 11 so that the camera lens 13 can be visually recognized from the outside via the opening 11d.

For example, the camera 12 performs imaging in a rear side direction of the vehicle M (hereinafter, the vehicle M may represent a vehicle body). The rear side direction is, for example, a direction having an angle greater than or equal to a predetermined angle (for example, about 10 degrees) from a directly horizontal direction (a side direction) of the vehicle M to a rear side. The camera 12 is mounted within the camera housing 11 so that an optical axis is directed in the rear side direction.

The camera 12 images the inside of a space in the rear side direction at a predetermined viewing angle. A region imaged by the camera 12 does not include a region in a side direction (a left-right direction) of the vehicle M. A region in the side direction of the vehicle M may be monitored by another sensing device such as, for example, a light detection and ranging (LIDAR) sensor.

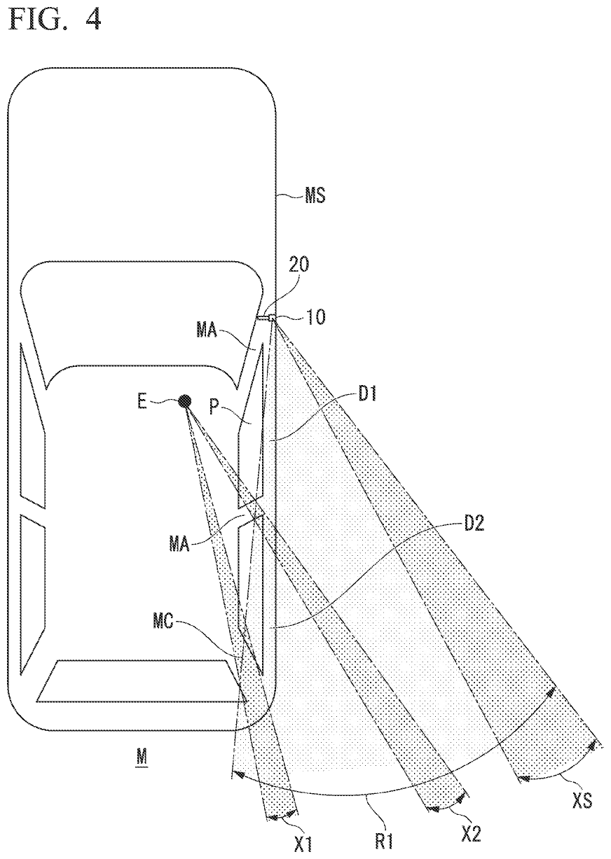

A range of the rear side direction imaged by the camera 12 is defined as a first region R1. FIG. 4 is a plan view showing an example of the first region R1. The first region R1 includes, for example, a part of a side surface MS of the vehicle M.

The first region R1 includes, for example, blind spots X1 and X2 having dead angles when viewed from a viewpoint E of the driver's seat. The blind spots X1 and X2 are caused, for example, by a B-pillar between a front seat and a rear seat and a C-pillar adjacent to a rear windshield. The first region R1 also includes a region that can be a blind spot XS of the side mirrors viewed from a position of the driver's viewpoint E on the driver's seat S if it is assumed that the side mirrors are installed.

The first region R1 can be set with a viewing angle wider than the visual field obtained by the side mirrors by the camera 12. Although the camera 12 shows a dead angle caused by a pillar or the like of the vehicle M in, for example, FIG. 4, the viewing angle of the camera 12 may be set to be wide in a vertical direction so that the dead angle caused by a side door D1 on the driver's seat side or a side door D2 on the rear seat side is also included in the first region R1. The image captured by the camera 12 is displayed on the display unit 40.

The camera 12 may perform imaging in the front side direction of the vehicle M. The front side direction is, for example, a direction having an angle greater than or equal to a predetermined angle (for example, about 10 degrees) from the directly horizontal direction side (the side direction) of the vehicle M to the front side.

The stay 20 is a support member for fixing the imaging unit 10 to the vehicle M. A base end 21 of the stay 20 is attached to an exterior part of a vehicle body of the vehicle M. The stay 20 is formed so that air resistance is reduced in the traveling direction of the vehicle M and a cross section has a streamlined shape or a shape having rounded corners.

The camera housing 11 is attached to a distal end 22 of the stay 20. The stay 20 is formed so that the camera housing 11 protrudes outward in a width direction (a Y-axis direction) of the vehicle M. The camera housing 11 is fixed away from the vehicle M by the stay 20.

Thereby, the camera housing 11 does not disturb the air flow on the surface of the vehicle M and the stay 20 is exclusively in contact with the air flow on the surface of the vehicle M. As described above, because the stay 20 is formed in a shape that reduces the air resistance, the air resistance of the vehicle M can be reduced by these structures. Further, the camera housing 11 can secure a visual field close to the door mirror by separating the stay 20 from the vehicle M and can eliminate the need for image processing of the image displayed on the display unit 40 or reduce the processing load.

A structure (hereinafter referred to as a “structure Q”) in which the imaging unit 10 and the stay 20 are combined can be mounted at various mounting positions in the vehicle M. This will be described below.

The structure Q is disposed in the vehicle M so that an outermost part of the structure Q is disposed inward from an outermost part of the vehicle M. The outermost part of the structure Q is a position farthest from the central surface of the vehicle M in the width direction of the vehicle M. That is, the outermost part of the structure Q does not protrude outward from the outermost part of the vehicle M in the width direction.

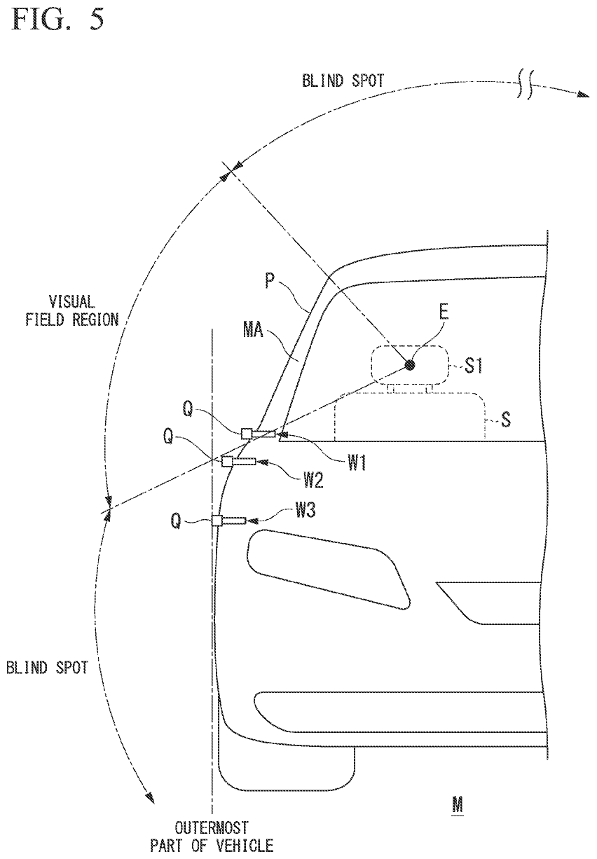

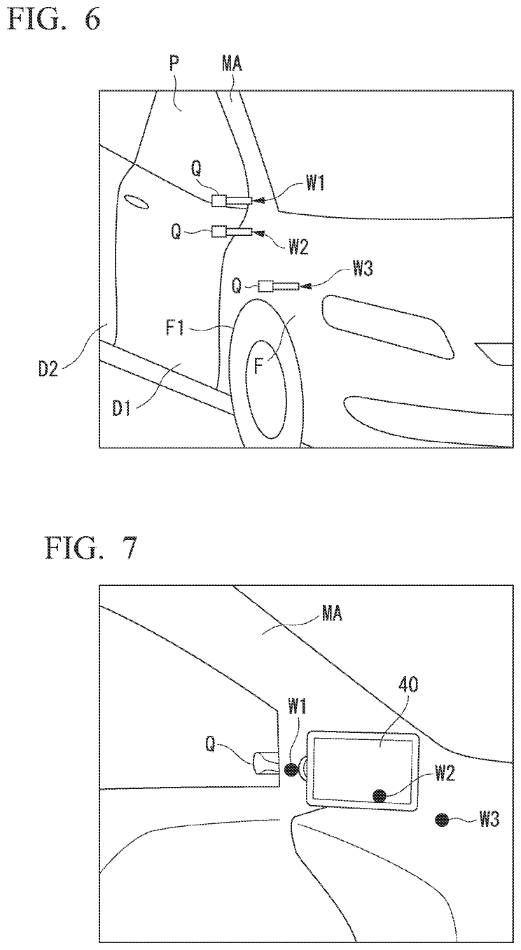

FIG. 5 is a front view showing an example of a pattern of mounting positions of the structure Q. FIG. 6 is a perspective view showing an example of a pattern of mounting positions of the structure Q.

In the first example, Q is attached to, for example, an A-pillar MA of the vehicle M. The A-pillar MA is a pillar adjacent to the front windshield among the pillars connecting the vehicle body and the roof. For example, the A-pillar MA is inclined in a direction in which the A-pillar MA falls toward the rear side of the vehicle M when viewed in the side surface direction of the vehicle M. For example, the A-pillar MA is inclined in a direction in which the A-pillar MA falls toward the center of the vehicle M when viewed in the front direction of the vehicle M.

For example, a first position W1 is disposed in the vicinity of the base end of the A-pillar MA in the A-pillar MA. The base end of the A-pillar MA is the root of the A-pillar MA that stands up from the frame of the vehicle M. For example, the base end of the A-pillar MA is a part in contact with a corner at the lower part of the front windshield adjacent to the A-pillar MA and a corner at the lower part of the front direction of a side windshield P adjacent to the A-pillar MA.

The vicinity of the base end of the A-pillar MA is, for example, a region within a predetermined range (for example, within several tens of centimeters [cm]) from the base end. As a result, the A-pillar MA, a windshield frame of the side door, the side door, and a front fender F are included in the vicinity of the base end of the A-pillar MA.

When the structure Q has been attached to the first position W1, the structure Q is visually recognized from the viewpoint E at a position of the seat S through the side windshield P. The viewpoint E is set so that the viewpoint E is included in a predetermined region above the seat S, for example, in consideration of individual differences of the driver. For example, the predetermined region above the seat S is located at a position overlapping a region of a headrest S1 of the seat S when viewed from the front side.

A dead angle and a visual field from the viewpoint E at the position of the driver's seat are set so that a width of a predetermined range is provided in a range viewed from each position within the predetermined region above the seat S.

Accordingly, the structure Q is disposed at a position where the structure Q is visually recognizable when viewed from each position included within the predetermined region present in a region above the seat S in the driver's seat of the vehicle M.

In the first example, the structure Q is provided so that the structure Q does not protrude from the outermost part of the vehicle M in the width direction. However, if the structure Q is provided at a position where visual recognition by the driver is possible, the driver can visually recognize the structure Q in a manner similar to that of the current side mirror and can perform a widthwise shifting operation or the like, so that the structure Q may be provided to protrude from the outermost part of the vehicle M in the width direction. Also, the structure Q may be provided so that the structure Q protrudes from the outermost part of the vehicle M in the width direction by giving priority to ensuring a visual field of the camera 10 close to that of the side mirror.

When the driver performs a driving operation such as a widthwise shifting operation on the vehicle M to the wall, the driver can drive the vehicle M with the same sensation as a sensation of looking at the side mirror using the structure Q capable of being visually recognized as a mark.

In the second example, the structure Q is attached to the second position W2. For example, the second position W2 is present at a position lower than the first position W1 at the base end of the A-pillar MA of the vehicle M. The second position W2 is disposed, for example, on the fender F or the side door D1 of the front part.

For example, the second position W2 is present at a position overlapping the fender F of the front part of the vehicle M when viewed from the side surface. The fender F is, for example, a panel of a side surface in the front part of the vehicle M in which a front wheel arch F1 is formed. For example, the fender F is formed with an inclined surface having a non-vertical gradient so that the fender F covers the front wheel. The second position W2 is disposed, for example, in a region where the inclined surface is formed in the fender F.

A gradient is formed on the inclined surface of the fender F so that the outermost part of the structure Q in the vehicle width direction is inward from the outermost part of the vehicle M in the vehicle width direction in a state in which the structure Q is attached to the second position W2.

The second position W2 may be disposed in another region instead of a region where the inclined surface is formed in the fender F. The second position W2 may be disposed on the side door D1 on the driver's seat side or the side door D2 on the rear seat, for example, as long as the outermost part of the structure Q does not exceed the outermost part of the vehicle M. Because the structure Q disposed at the second position W2 is disposed at a position of a dead angle from the driver's viewpoint E, the structure Q is not visually recognized through the side windshield P.

When the structure Q has been attached to the second position W2, the visual field from the side windshield P is widened without being blocked by the structure Q.

In the third example, the structure Q is attached to the third position W3. The third position W3 is present, for example, at a position overlapping the fender F of the vehicle M when viewed from the side direction of the vehicle M. For example, the third position W3 is disposed on the front side of the vehicle M from the second position W2 in the fender F.

For example, the third position W3 is disposed on an inclined surface formed near the wheel arch F1 in the fender F. The third position W3 is disposed within a blind spot that is not visually recognized from each position in a predetermined region including the viewpoint E. Because the structure Q disposed at the third position W3 is disposed at a position having a dead angle from the driver's viewpoint E, the structure Q is not visually recognized through the side windshield P.

When the structure Q has been attached to the third position W3, the visual field from the side windshield P is widened without being blocked by the structure Q.

FIG. 7 is a diagram showing an example of an arrangement position of the structure Q viewed from the driver's viewpoint E. The first position W1, the second position W2, and the third position W3 when a passenger's seat side is viewed from the driver's seat are shown in FIG. 7.

The display unit 40 is attached, for example, in the vicinity of the base end of the A-pillar MA in the interior of the vehicle. With such an arrangement, the display unit 40 can provide the driver with a driving sensation similar to that of a side mirror. The driver visually confirms the display unit 40 and confirms an environment in a rear side direction of the vehicle M as if she or he were looking at the side mirror. By visually recognizing the display content of the display unit 40, the driver can confirm a surrounding situation of the vehicle M with the same sensation as that of the side mirror.

As described above, because the structure Q is not visually recognized from the side windshield P at the second position W2 or the third position W3, it is necessary to give the driver a sensation of a position of the structure Q protruding in the width direction of the vehicle M.

In particular, it is necessary to consider an influence of the presence or absence of side mirrors on the driver's driving sensation when an operation of widthwise shifting driving such as an operation of shifting the vehicle M to the wall is performed. When the driver drives the vehicle M without the side mirrors, the vehicle M can be moved closer to the wall side because there is no side mirror as compared with when the vehicle M with the side mirrors is driven. However, it is empirically known that a driver who drives a vehicle without the side mirrors feels a sense of uneasiness when the imaging unit 10 or the like is installed at a position where the imaging unit 10 or the like cannot be viewed because there is no outermost part of the vehicle capable of being visually recognized.

Because the structure Q does not protrude from the outermost part of the vehicle M to the outside, the driver can perform a widthwise shifting operation without feeling the sense of uneasiness as described above as compared with when the side mirrors are provided. Also, if the driver can be made aware of the outermost part of the vehicle M by displaying a mark as described below, the driver's uneasiness can be reduced.

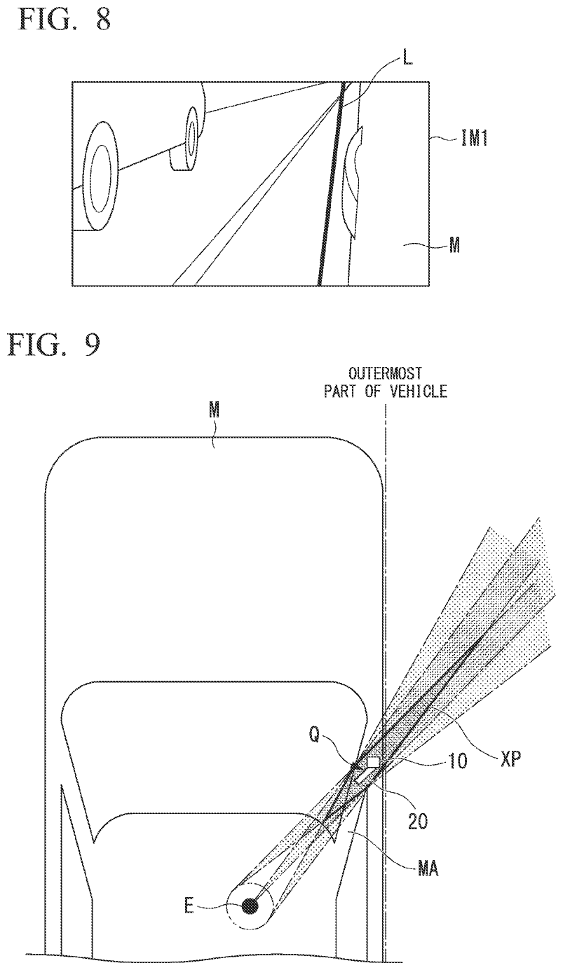

FIG. 8 is a diagram showing an example of an image IM1 displayed on the display unit 40. The image IM1 including the outermost part of the vehicle M on the image is displayed on the display unit 40 to support a vehicle sensation of the driver. For example, when the outermost part of the vehicle M is a wheel arch of the fender of the rear part, the display unit 40 displays the first region R1 so that the first region R1 includes the wheel arch.

However, because the outermost part of the vehicle M is not necessarily the wheel arch of the fender of the rear part or the like, the display unit 40 may display an auxiliary mark representing a position on an image of the outermost part of the vehicle M in the width direction together with the image IM1 to support a vehicle sensation of the driver. The display unit 40 displays the image IM1 in which the auxiliary mark is superimposed on the image captured by the imaging unit 10.

The display of the auxiliary mark is, for example, display in which a position corresponding to the outermost part of the vehicle M is superimposed on a road surface in the image captured by the imaging unit 10 with a straight line L or the like. The auxiliary mark may be displayed not only in the straight line L but also in any display form as long as a position of the outermost part of the vehicle M such as a point, an arrow, or a colored region can be determined.

Also, in addition to or instead of the outermost part of the vehicle M, another auxiliary mark such as a straight line offset by a predetermined width from the outermost part may be displayed on the display unit 40. Another auxiliary mark may be arbitrarily displayed on the display unit 40 according to a user's setting.

Although a driving operation such as a widthwise shifting operation is performed while the driver is aware of the outermost part of the vehicle M in the width direction by visually recognizing the side mirrors in vehicles with the side mirrors, the outermost part of the vehicle M cannot be visually recognized in the width direction by the driver because the side mirrors capable of being visually recognized are eliminated and there is a possibility that the widthwise shifting operation will be difficult.

As described above, by displaying the outermost part of the vehicle M or the auxiliary mark such as the straight line L on the image of the display unit 40, the widthwise shifting operation is easy even if the driver cannot visually recognize the outermost part of the vehicle M in the width direction and the driver can perform the driving operation such as the widthwise shifting operation without feeling a sense of uneasiness about a distance between the vehicle M and the wall or the like.

According to the peripheral information acquisition device 1 described above, it is possible to provide a driving environment that does not give a sense of discomfort in the vehicle sensation of the driver. According to the peripheral information acquisition device 1, when the structure Q is disposed at positions where the side mirrors are disposed, it is possible to provide a driving environment equivalent to that of the side mirrors.

Further, according to the peripheral information acquisition device 1, when the structure Q is disposed at a position that cannot be visually recognized from the driver's seat, the driver's visual field from the side windshield P can be secured more widely. In addition, according to the peripheral information acquisition device 1, a driving environment that supports the driving sensation of the driver can be provided by displaying the outermost part of the vehicle M or an auxiliary mark such as the straight line L on the display unit 40.

### Modified Example

FIG. 9 is a plan view showing an example of a mounting position of the structure Q according to a modified example. In a vehicle M in which the fender F and the side door D1 are nearly formed in a vertical shape, it may be difficult to determine a position where the structure Q is attached to the fender F or the side door D1.

Specifically, in the vehicle M in which the fender F and the side door D1 are formed in a vertical shape or a shape close to a vertical shape, such as a one-box car, the fender F and the side door D1 may have an outermost part of the vehicle or a width close to the outermost part in many cases. It is difficult to dispose the structure Q on the fender F and the side door D1 of the vehicle M so that the structure Q does not protrude from the outermost part of the vehicle. Accordingly, in the vehicle M as described above, it is necessary to dispose the structure Q at a position other than those of the fender F and the side door D1.

The structure Q according to the modified example is attached to the A-pillar MA. The A-pillar MA is inclined rearward when viewed from the side surface of the vehicle M and is inclined inward when viewed from the front of the vehicle M.

The structure Q is disposed in the middle of the A-pillar MA. At such a position, the structure Q is disposed so that the structure Q does not protrude from the outermost part of the vehicle M. Further, the structure Q is disposed within a blind spot XP caused by the A-pillar MA when viewed from the driver's viewpoint E within the vehicle. The structure Q is set at a position within the blind spot XP that is not visually recognized from each position in a predetermined region including the viewpoint E.

The stay 20 is attached to the A-pillar MA to support the imaging unit 10 and is formed so that the structure Q fits in the blind spot XP.

According to the above-described modified example, the visual field of the side windshield P is secured when viewed from the driver's viewpoint E. The imaging unit 10 can image a surrounding environment in the front side direction and the rear side direction of the vehicle M in a state in which the structure Q does not protrude from the outermost part of the vehicle M.

Although modes for carrying out the present invention have been described above using embodiments, the present invention is not limited to the embodiments and various modifications and substitutions can also be made without departing from the scope and spirit of the present invention.

For example, the structure Q disposed at the first position W1 can be visually recognized from the driver's viewpoint E. On the other hand, the structure Q is disposed in the blind spot from the viewpoint E instead of a region capable of being visually recognized from the driver's viewpoint E and a virtual image of a mark such as an auxiliary line at a position visible through the side windshield P from the driver's viewpoint may be displayed using a head-up display or the like to support a vehicle width sensation of the driver. The virtual image of this mark corresponds to a position of the outermost part of the vehicle M in the width direction when viewed from the predetermined region including the viewpoint E and is displayed to be superimposed on the visual field viewed through the side windshield P. The driver can perform a driving operation by targeting the mark appearing on the side windshield P.

### REFERENCE SIGNS LIST

1 Peripheral information acquisition device
10 Imaging unit
11 Camera housing
11c Back surface
11d Opening
12 Camera
13 Camera lens
20 Stay
21 Base end
22 Distal end
30 Information acquisition unit
40 Display unit
50 Display control unit
D1 Side door
D2 Side door
EL Organic
F Fender
F1 Wheel arch
IM1 Image
L Straight line
M Vehicle
MA A-pillar
MB B-pillar
MC C-pillar
P Side windshield
Q Structure
S Seat
S2 Headrest
W1 First position
W2 Second position
W3 Third position

What is claim is:

1.-9. (canceled)

10. A peripheral information acquisition device comprising:
an imaging unit configured to perform imaging in a front side direction or a rear side direction of a vehicle; and
a stay configured to support the imaging unit on the vehicle,
wherein the stay is formed so that the imaging unit is allowed to protrude outward from a side surface of the vehicle in a width direction of the vehicle,
wherein, in a structure including the imaging unit and the stay, an outermost part of the structure in the width direction of the vehicle is disposed more inward in the width direction of the vehicle than an outermost part of the vehicle in the width direction, and
wherein the imaging unit is disposed in a region having a dead angle when viewed from a viewpoint of a driver of the vehicle via the stay.

11. The peripheral information acquisition device according to claim 10, wherein the imaging unit is disposed in a region having a dead angle when viewed from a predetermined position in a region above a seat of the driver of the vehicle via the stay.

12. The peripheral information acquisition device according to claim 10, wherein the imaging unit is attached to the vehicle without side mirrors via the stay and performs imaging in the rear side direction including a side surface of a rear part of the vehicle.

13. The peripheral information acquisition device according to claim 10, wherein the imaging unit is disposed on a pillar adjacent to a front windshield of the vehicle via the stay.

14. The peripheral information acquisition device according to claim 13, wherein the imaging unit is disposed on the pillar within a blind spot caused by the pillar via the stay.

15. The peripheral information acquisition device according to claim 10, wherein the imaging unit is disposed on a non-vertical inclined surface in a fender of a front part of the vehicle via the stay.

16. The peripheral information acquisition device according to claim 10, further comprising a display unit configured to display an image captured by the imaging unit,
wherein the display unit displays a mark representing a position on an image of a part of a side surface of the vehicle or the outermost part of the vehicle in the width direction together with the image.

17. A vehicle comprising:
an imaging unit configured to perform imaging in a front side direction or a rear side direction of a vehicle body; and
a stay configured to support the imaging unit on the vehicle body,
wherein the stay is formed so that the imaging unit is allowed to protrude outward from a side surface of the vehicle body in a width direction of the vehicle body,
wherein, in a structure including the imaging unit and the stay, an outermost part of the structure in the width direction of the vehicle body is disposed more inward in the width direction of the vehicle body than an outermost part of the vehicle body in the width direction, and
wherein the imaging unit is disposed in a region having a dead angle when viewed from a viewpoint of a driver of the vehicle via the stay.
